(19) United States
(12) Patent Application Publication
(10) Pub. No.: US 2026/0201519 A1
(43) Pub. Date: Jul. 16, 2026

(54) NON-ORIENTED ELECTRICAL STEEL SHEET AND METHOD OF MANUFACTURING SAME

(71) Applicant: POSCO CO., LTD, Pohang-si, Gyeongsangbuk-do (KR)

(72) Inventors: Jae-Hoon Kim, Gwangyang-si, Jeollanam-do (KR); Sang-Woo Lee, Pohang-si, Gyeongsangbuk-do (KR); Won-Seog Bong, Incheon (KR)

(73) Assignee: POSCO CO., LTD, Pohang-si, Gyeongsangbuk-do (KR)

(21) Appl. No.: 19/137,595

(22) PCT Filed: Dec. 13, 2023
(86) PCT No.: PCT/KR2023/020588

§ 371 Date: Jun. 10, 2025

(30) Foreign Application Priority Data
Dec. 21, 2022 (KR) 10-2022-0181128

(51) Int. Cl. C22C 38/34; C21D 6/00; C21D 8/1216; C21D 8/1244; C21D 9/46; C22C 38/00; C22C 38/02; C22C 38/04; C22C 38/06; C22C 38/28; C22C 38/38; H01F 1/147

(52) U.S. Cl. CPC C22C 38/34; C21D 6/002; C21D 6/005; C21D 6/008; C21D 8/1222; C21D 8/1233; C21D 8/1261; C21D 9/46; C22C 38/001; C22C 38/002; C22C 38/02; C22C 38/04; C22C 38/06; C22C 38/28; C22C 38/38; H01F 1/14791; C22C 2202/02

(57) ABSTRACT

The present invention relates to a non-oriented electrical steel sheet and a method of manufacturing same and, more specifically, to a non-oriented electrical steel sheet which can be preferably used as an iron core of a motor, etc., and a method of manufacturing same. The purpose of one aspect of the present invention is to provide a non-oriented electrical steel sheet having excellent magnetic properties and a method of manufacturing same.

### TECHNICAL FIELD

The present disclosure relates to a non-oriented electrical steel sheet and a method for manufacturing the same, and more specifically, to a non-oriented electrical steel sheet that can be preferably used as a core of a motor, or the like, and a method for manufacturing the same.

### BACKGROUND ART

Recently, as disasters caused by a climate change increase, countries around the world are announcing carbon neutrality roadmaps for 2050. Total carbon emissions globally in '20 reached 39 billion tons, of which an amount emitted by internal combustion engines accounted for 24%, reaching 9.4 billion tons. Therefore, there is a huge demand to achieve carbon neutrality in this field through the electrification of internal combustion engines. To this end, electrification is rapidly progressing in the mobility field, led by electric vehicles. The characteristics required for a driving motor in new mobility devices are increasing a driving distance and increasing a maximum speed. This is directly related to low iron loss characteristics of an electrical steel sheet. If the iron loss of the electrical steel sheet is low, efficiency is further improved, so the driving distance may be increased. Therefore, low iron loss characteristics of an electrical steel sheet is essential, and to this end, large amounts of Si, Al, and Mn are added in the electrical steel sheet to secure high-frequency low iron loss.

However, impurities present in steel cause the formation of precipitates such as nitrides and carbides, which hinder grain growth and magnetic domain movement and deteriorate iron loss. Therefore, it is necessary to improve magnetism by controlling the precipitates which hinder grain growth and magnetic domain movement.

### SUMMARY OF INVENTION

### Technical Problem

An aspect of the present disclosure is to provide a non-oriented electrical steel sheet having excellent magnetism and a method for manufacturing the same.

### Solution to Problem

According to an aspect of the present disclosure, provided is a non-oriented electrical steel sheet, the non-oriented electrical steel sheet including by weight %: 3.3 to 4.3% of Si, 0.8 to 1.7% of Al, 0.3 to 2.5% of Mn, 0.01 to 0.05% of Cr, 0.005% or less (excluding 0%) of S, 0.01% or less (excluding 0%) of P, 0.001 to 0.004% of N, 0.001 to 0.005% of Ti, with a remainder of Fe and other inevitable impurities, and satisfying the following Relational Expression 1, wherein a total number density of nitrides and carbides having a diameter of 1 to 3 μm of 50/mm² or less.

$$0.02 \leq Al \times Ti / Cr \leq 0.8 \qquad [ Relational Expression 1 ]$$

The non-oriented electrical steel sheet may further include at least one of 0.005% or less of C, 0.005% or less of Nb, and 0.005% or less of V.

The non-oriented electrical steel sheet may further include at least one of 0.1% or less of Sn, 0.1% or less of Sb, 0.05% or less of Ni, 0.005 to 0.2% of Cu, and 0.01% or less of Zn.

The non-oriented electrical steel sheet may further include at least one of 0.03% or less of Mo, 0.0050% or less of B, 0.005% or less of Ca, and 0.005% or less of Mg.

The non-oriented electrical steel sheet may further include 0.20% or less (excluding 0%) of at least one of Bi, Pb, Ge, and As, individually or in a total content thereof.

The non-oriented electrical steel sheet may have a coercive force of 40 A/m or less even after magnetization of up to 2000 A/m.

According to another aspect of the present disclosure, provided is a method for manufacturing a non-oriented electrical steel sheet, the method including operations of: heating a slab including by weight %, 3.3 to 4.3% of Si, 0.8 to 1.7% of Al, 0.3 to 2.5% of Mn, 0.01 to 0.05% of Cr, 0.005% or less (excluding 0%) of S, 0.01% or less (excluding 0%) of P, 0.001 to 0.004% of N, 0.001 to 0.005% of Ti, with a remainder of Fe and other inevitable impurities, and satisfying the following Relational Expression 1, at a temperature within a range of 1100 to 1250° C.; finish hot rolling the heated slab at a temperature within a range of 800 to 1000° C. to obtain a hot-rolled steel sheet; cold rolling the hot-rolled steel sheet at a reduction ratio of 70 to 95% to obtain a cold-rolled steel sheet; and final annealing the cold-rolled steel sheet, wherein the final annealing includes a heating process and a soaking process, and a maximum heating temperature is 50° C. or more than a soaking temperature, and a soaking time is 30 seconds or longer than a heating time.

$$0.02 \leq Al \times Ti / Cr \leq 0.8 \qquad [ Relational Expression 1 ]$$

The slab may further include at least one of 0.005% or less of C, 0.005% or less of Nb, and 0.005% or less of V.

The slab may further include at least one of 0.1% or less of Sn, 0.1% or less of Sb, 0.05% or less of Ni, 0.005 to 0.2% of Cu, and 0.01% or less of Zn.

The slab may further include at least one of 0.03% or less of Mo, 0.0050% or less of B, 0.005% or less of Ca, and 0.005% or less of Mg.

The slab may further include 0.20% or less (excluding 0%) of at least one of Bi, Pb, Ge and As, individually or in a total content thereof.

After the obtaining the hot-rolled steel sheet, annealing the hot-rolled steel sheet at a temperature within a range of 850 to 1150° C. may be further included.

The cold rolling may be performed once or twice.

### Advantageous Effects of Invention

According to an aspect of the present disclosure, a non-oriented electrical steel sheet having excellent magnetism and a method for manufacturing the same may be provided.

### BEST MODE FOR INVENTION

In order to improve iron loss of a non-oriented electrical steel sheet, large amounts of Si, Al, and Mn, which are elements increasing resistivity, should be added, but precipitates which hinder grain growth and magnetic domain movement should also be actively controlled. In particular, precipitates such as nitrides and carbides are precipitated in microscopic sizes at grain boundaries, thereby lowering iron loss. Accordingly, the present inventors have recognized that a non-oriented electrical steel sheet with excellent magnetism may be manufactured by optimizing alloy components affecting the formation of precipitates and controlling a temperature and time of a heating zone and a soaking zone, particularly in a final annealing process, among the manufacturing conditions, thereby managing the precipitates, thereby completing the present disclosure.

Hereinafter, a non-oriented electrical steel sheet according to an embodiment of the present disclosure will be described. A content of an alloy composition described below refers to % by weight, unless otherwise specified.

Silicon (Si): 3.3 to 4.3%

Silicon (Si) is an element serving to increase resistivity of a material and lower iron loss. When the content of Si is less than 3.3%, an effect of improving high-frequency iron loss is insignificant. When the content of Si exceeds 4.3%, productivity and die-casting properties may deteriorate due to an increase in hardness. Therefore, it is preferable that the content of Si is in the range of 3.3 to 4.3%. A lower limit of the content of Si is more preferably 3.35%, and even more preferably 3.40%. An upper limit of the content of Si is more preferably 4.25%, and even more preferably 4.20%.

Aluminum (Al): 0.8 to 1.7%

Aluminum (Al) is an element serving to increase resistivity of a material and lower iron loss. When the content of Al is less than 0.8%, there is no effect of reducing high-frequency iron loss, and nitrides are formed finely, deteriorating magnetism. When the content of Al exceeds 1.7%, it causes a problem of changing properties of a mold flux during a continuous casting process, which significantly reduces productivity. Therefore, it is preferable that the content of Al is in the range of 0.8 to 1.7%. A lower limit of the content of Al is more preferably 0.85%, and even more preferably 0.90%. An upper limit of the content of Al is more preferably 1.65%, and even more preferably 1.60%.

Manganese (Mn): 0.3 to 2.5%

Manganese (Mn) is an element serving to increase resistivity of a material, improve iron loss, and form sulfides. When the content of Mn is less than 0.3%, MnS is finely precipitated, deteriorating magnetism. When the content of Mn exceeds 2.5%, the formation of a [111] texture, which is unfavorable to magnetism, is promoted, causing a rapid decrease in magnetic flux density. Therefore, it is preferable that the content of Mn is in the range of 0.3 to 2.5%. A lower limit of the content of Mn is more preferably 0.35%, even more preferably 0.40%, and most preferably 0.45%. An upper limit of the content of Mn is more preferably 2.45%, even more preferably 2.40%, and most preferably 2.35%.

Chromium (Cr): 0.01 to 0.05%

Chromium (Cr) can cause segregation without directly forming precipitates, but Cr also forms solid solutions with Al and Ti through various temperature changes during the manufacturing process, but forms an intermetallic compound to hinder magnetic domain movement like precipitates, thereby deteriorating magnetism. When the content of Cr is less than 0.01%, it is difficult to obtain a segregation effect sufficiently. When the content of Cr exceeds 0.05%, a large amount of intermetallic compounds are formed, which causes magnetism to deteriorate.

Sulfur (S): 0.005% or less (excluding 0%)

Sulfur (S) reacts with Mn, Cu, or the like to form sulfides, which deteriorates magnetism, so a content of S should be controlled to 0.005% or less.

Phosphorus (P) 0.01% or less (excluding 0%)

Phosphorus (P) hinders grain boundary bonding to increase brittleness, thereby deteriorating rolling productivity. In particular, in steel having 3.2% of Si added, a content of P should be controlled to 0.01% or less.

Nitrogen (N): 0.001 to 0.004%

Nitrogen (N) reacts Al, Ti, or the like to form fine nitrides. Since N in the atmosphere is dissolved into steel, to control a content of N to be less than 0.001%, process costs increase excessively. When the content of N exceeds 0.004%, grain growth property deteriorates due to excessive formation of nitrides, resulting in poor magnetism. A lower limit of the content of N is more preferably 0.0012%, even more preferably 0.0014%, and most preferably 0.0016%. An upper limit of the content of N is more preferably 0.0035%, even more preferably 0.0030%, and most preferably 0.0025%.

Titanium (Ti) 0.001 to 0.005%

Titanium (Ti) forms various kinds of fine precipitates such as nitrides and carbides. To control the content of Ti to be less than 0.001%, process costs increase excessively. When the content of Ti exceeds 0.005%, a large amount of precipitates are formed, making it difficult to obtain an appropriate grain size.

The remaining component of the present disclosure is iron (Fe). However, since in the common manufacturing process, unintended impurities may be inevitably incorporated from raw materials or the surrounding environment, the component may not be excluded. Since these impurities are known to any person skilled in the common manufacturing process, the entire contents thereof are not particularly mentioned in the present specification.

The non-oriented electrical steel sheet of the present disclosure may further include at least one of 0.005% or less of C, 0.005% or less of Nb, and 0.005% or less of V.

Carbon (C): 0.005% or less

Carbon (C) reacts with N, Ti, Nb, V, or the like, to form fine carbides, which hinder grain growth property and magnetic domain movement, and an upper limit of a content of C is limited to 0.005%. More specifically, the content of C may be 0.0001 to 0.005%. More specifically, the content of C may be 0.0005 to 0.003%.

Niobium (Nb): 0.005% or less

Niobium (Nb) combines with C, N, or the like, to form fine nitrides, which hinders magnetic domain movement, so an upper limit of a content of Nb is limited to 0.005%. More specifically, the content of Nb may be 0.0001 to 0.005%. More specifically, the content of Nb may be 0.0005 to 0.003%.

Vanadium (V): 0.005% or less

Vanadium (V) combines with C, N, or the like, to form fine nitrides, which hinders magnetic domain movement, so an upper limit of a content of V is limited to 0.005%. More specifically, the content of V may be 0.0001 to 0.005%. More specifically, the content of V may be 0.0005 to 0.003%.

The non-oriented electrical steel sheet of the present disclosure may further include at least one of 0.1% or less of Sn, 0.1% or less of Sb, 0.05% or less of Ni, 0.005 to 0.2% of Cu, and 0.01% or less of Zn.

Tin (Sn): 0.1% or less

Tin (Sn) is an element which segregates at grain boundaries, and is added to improve magnetic properties by suppressing the diffusion of nitrogen through grain boundaries, and suppressing a {111} texture, which is detrimental to magnetism, and increasing a {100} texture, which is advantageous to magnetism. When a content of Sb exceeds 0.1%, it hinders grain growth, reduces magnetism, and makes rolling properties poor. More specifically, the content of Sn may be 0.001 to 0.1%. More specifically, the content of Sn may be 0.005 to 0.08%.

Antimony (Sb): 0.1% or less

Antimony (Sb) is an element which segregates at grain boundaries, and is added to improve magnetic properties by suppressing the diffusion of nitrogen through grain boundaries, and suppressing a {111} texture, which is detrimental to magnetism, and increasing a {100} texture, which is advantageous to magnetism. When a content of Sb exceeds 0.1%, it hinders grain growth, reduces magnetism, and makes rolling properties poor. More specifically, the content of Sb may be 0.001 to 0.1%. More specifically, the content of Sb may be 0.005 to 0.08%.

Nickel (Ni): 0.05% or less

Nickel (Ni) reacts with impurity elements to form fine sulfides, carbides, and nitrides, which have a detrimental effect on magnetism, so an upper limit of a content of Ni is limited to 0.05%. More specifically, the content of Ni may be 0.0001 to 0.050%. More specifically, the content of Ni may be 0.001 to 0.030%.

Copper (Cu): 0.005 to 0.2%

Copper (Cu) serves to form sulfides with Mn. When a content of Cu is less than 0.005%, (Cu·Mn)S may be finely precipitated, thereby deteriorating magnetism. When the content of Cu exceeds 0.2%, high-temperature brittleness may occur, which can cause cracks to form during continuous casting or hot rolling. More specifically, the content of Cu may be 0.010 to 0.1%.

Zinc (Zn): 0.01% or less

Zinc (Zn) acts as an impurity and may lower magnetism, so an upper limit of a content of Zn is limited to 0.01%. More specifically, the content of Zn may be 0.0001 to 0.01%. More specifically, the content of Zn may be 0.001 to 0.008%.

The non-oriented electrical steel sheet of the present disclosure may further include at least one of 0.03% or less of Mo, 0.0050% or less of B, 0.005% or less of Ca, and 0.005% or less of Mg.

Since these elements may react with C, S, N, or the like, which are inevitably included, to form fine carbides, nitrides, or sulfides, which may adversely affect magnetism, upper limits thereof may be limited as described above.

The non-oriented electrical steel sheet of the present disclosure may further include 0.20% or less (excluding 0%) of at least one of Bi, Pb, Ge, and As, individually or in a total content thereof.

When the above-described elements are additionally added, the elements are segregated at grain boundaries, thereby alleviating stress concentration at grain boundaries during cold rolling, thereby suppressing recrystallization of <111>/ND orientation grains during recrystallization annealing, which is a subsequent process, thereby improving magnetic flux density. If these elements are added appropriately, the above-described effects can be additionally obtained, but if these elements are included in too much, a large amount of segregation may occur, suppressing grain growth and resulting in rather deteriorating magnetic flux density and iron loss. More specifically, 0.0001 to 0.20% of at least one of Bi, Pb, Ge, and As, individually or in a total content thereof may be included. More specifically, 0.0001 to 0.10% of at least one of Bi, Pb, Ge, and As, individually or in a total content thereof may be included.

It is preferable that the non-oriented cold rolled steel sheet of the present disclosure satisfy the alloy composition described above and the following Relational Expression 1.

$$0.02 \leq Al \times Ti / Cr \leq 0.8 \qquad [ Relational Expression 1 ]$$

Al, Cr, and Ti promote the formation of precipitates, and form solid solutions depending on heat treatment conditions. Therefore, if the heat treatment conditions are appropriately adjusted, the size and fraction of precipitates may be controlled. When the value of Al×Ti/Cr is less than 0.02, an amount of Cr is excessive, so that Cr-based intermetallic compounds are formed, thereby deteriorating magnetism. When the value of Al×Ti/Cr exceeds 0.8, an amount of Al or Ti is excessive, so that the precipitate may not be controlled. A lower limit of the value of Al×Ti/Cr is more preferably 0.025, even more preferably 0.03, and most preferably 0.035. An upper limit of the value of Al×Ti/Cr is more preferably 0.75, and most preferably 0.7.

It is preferable that the non-oriented cold-rolled steel sheet of the present disclosure has a total number density of nitrides and carbides having a diameter of 1 to 3 μm of 30/mm² or less. Fine nitrides and carbides having a diameter of 1 to 3 μm hinder grain growth and magnetic domain movement, thereby deteriorating magnetism. Therefore, it is necessary to minimize such fine nitrides and carbides. When the total number density of nitrides and carbides with the diameter of 1 to 3 μm is controlled to of 50/mm² or less, grain growth property is improved and magnetic domain movement becomes easier during magnetization. The nitrides and carbides may be observed through SEM, and nitrides may refer to precipitates containing 5 wt % or more of N, and carbides may be defined as precipitates containing 5 wt % or more of C.

The non-oriented electrical steel sheet of the present invention provided described above may have a coercive force of 40 A/m or less even after magnetization of up to 2000 A/m. In the present disclosure, since the lower the coercive force, the more advantageous it is, a lower limit of the coercive force is not limited. However, the lower limit of the coercive force may be, as an example, 20 A/m.

Resistivity is better, the larger it is, for reducing eddy current loss in a high-frequency rotating machine, but if resistivity becomes excessively large, magnetic flux density may become inferior. The non-oriented electrical steel sheet of the present disclosure may have resistivity of 55 to 85 μΩcm. Meanwhile, the resistivity may be estimated from 13.25+11.3×(Si+Al+Mn/2).

Hereinafter, a method for manufacturing a non-oriented electrical steel sheet according to an embodiment of the present disclosure will be described.

First, a slab satisfying the above-described alloy composition and Relational Expression 1 is heated at a temperature within a range of 1100 to 1250° C. When the slab heating temperature is lower than 1100° C., there is a disadvantage in that a rolling temperature is too low and rolling may not be performed to the desired thickness. When the slab heating temperature exceeds 1250° C., there is a disadvantage in that inclusions are finely precipitated during rolling, which deteriorates magnetism. Therefore, it is preferable that the slab heating temperature be within the range of 1100 to 1250° C. A lower limit of the slab heating temperature is more preferably 1110° C., even more preferably 1120° C., and most preferably 1130° C. An upper limit of the slab heating temperature is more preferably 1230° C., even more preferably 1210° C., and most preferably 1190° C.

Thereafter, the heated slab is subjected to finish hot rolling at a temperature within a range of 880 to 1000° C. to obtain a hot-rolled steel sheet. When the finish hot rolling temperature is lower than 800° C., there is a disadvantage in that a rolling load becomes too high. When the finish hot rolling temperature exceeds 1000° C., there is a disadvantage in that the shape control becomes difficult. A lower limit of the finish hot rolling temperature is more preferably 820° C., even more preferably 840° C., and most preferably 850° C. An upper limit of the finish hot rolling temperature is more preferably 980° C., even more preferably 960° C., and most preferably 950° C. After the obtaining the hot-rolled steel sheet, the hot-rolled steel sheet may be annealed at a temperature within a range of 850 to 1150° C. Through an annealing process of the hot-rolled steel sheet, crystal orientation, which is favorable to magnetism can be increased.

When an annealing temperature of the hot-rolled steel sheet is lower than 850° C., grains may not grow or may grow finely, which may result in a small increase in magnetic flux density. When the annealing temperature of the hot-rolled steel sheet exceeds 1150° C., the magnetic properties may rather deteriorate, and rolling workability may deteriorate due to deformation of the plate shape. Therefore, the annealing temperature of the hot-rolled steel sheet may range from 850 to 1150° C. A lower limit of the annealing temperature of the hot-rolled steel sheet is more preferably 870° C., even more preferably 890° C., and most preferably 910° C. An upper limit of the hot-rolled steel sheet annealing temperature is more preferably 1140° C., even more preferably 1130° C., and most preferably 1120° C. Meanwhile, annealing of hot-rolled steel sheet annealing may be omitted.

Thereafter, the hot-rolled steel sheet is cold rolled at a reduction ratio of 70 to 95% to obtain a cold-rolled steel sheet. When the cold reduction ratio is less than 70%, a deformation structure is uneven so there is a disadvantage in that a deviation in magnetism of a final product may increase. When the cold reduction ratio exceeds 95%, a texture structure, which is unfavorable to magnetism may develop, so there is a disadvantage in that the magnetic of a final product may deteriorate. Therefore, it is preferable that the cold reduction ratio is in the range of 70 to 95%. A lower limit of the cold reduction ratio is more preferably 72%, even more preferably 74%, and most preferably 76%. An upper limit of the cold rolling reduction ratio is more preferably 93%, even more preferably 91%, and most preferably 89%. The cold rolling may be performed once or twice to obtain the target thickness.

Thereafter, the cold-rolled steel sheet is finally annealed. The final annealing includes a heating process and a soaking process, and a maximum heating temperature is preferably 50° C. or more than a soaking temperature, and a soaking time is preferably 30 seconds or longer than a heating time. The reason for controlling the heating temperature high is to re-dissolve precipitates such as fine nitrides and carbides. The reason for controlling the soaking temperature low is to suppress grain growth and improve high-frequency iron loss. The reason for making the soaking time longer than the heating time is to reduce grain size irregularity and minimize magnetic deviation. When a difference between the maximum heating temperature and the soaking temperature is lower than 50° C. or a difference between the soaking time and the heating time is less than 30 seconds, it is difficult to sufficiently obtain the above-described effect. The difference between the maximum heating temperature and the soaking temperature is more preferably 53° C. or higher, even more preferably 55° C. or higher, and most preferably 58° C. or higher. The difference between the soaking time and the heating time is more preferably 33 seconds or longer, even more preferably 35 seconds or longer, and most preferably 38 seconds or longer. The greater the difference between the maximum heating temperature and the soaking temperature, the more advantageous it is, so in the present disclosure, an upper limit thereof is not specifically limited. However, the upper limit of the difference between the maximum heating temperature and the soaking temperature may be 100° C. as an example. The greater the difference between the soaking time and the heating time, the more advantageous it is, so in the present disclosure, an upper limit thereof is not specifically limited. However, the upper limit of the difference between the soaking time and the heating time may be 80 seconds as an example.

### MODE FOR INVENTION

Hereinafter, the present disclosure will be specifically described through the following Examples. However, it should be noted that the following examples are only for describing the present disclosure by illustration, and not intended to limit the right scope of the present disclosure. The reason is that the right scope of the present disclosure is determined by the matters described in the claims and reasonably inferred therefrom.

### Example

A slab having the alloy composition illustrated in Table 1 below was heated at a temperature of 1150° C., and the heated slab was then subjected to finish hot rolling at a temperature of 850° C. to obtain a hot-rolled steel sheet having a thickness of 2.0 mm. Thereafter, the hot-rolled steel sheet was annealed at a temperature of 1100° C. for 4 minutes and then pickled. Thereafter, the hot-rolled steel sheet was cold rolled at a reduction ratio of 87.5% to obtain a cold-rolled steel sheet having a thickness of 0.25 mm. Thereafter, the final annealing was performed under the conditions described in Table 2 below to manufacture a non-oriented electrical steel sheet. Meanwhile, the conditions described in Table 2 below were based on a surface temperature of the steel sheet.

For the non-oriented electrical steel sheet manufactured in this manner, the total number density of nitrides and carbides having a diameter of 1 to 3%) was measured using SEM, and after magnetized up to 2000 A/m, a coercive force was measured, and then the results were shown in Table 2 below.

Meanwhile, the coercive force was determined by measuring a hysteresis loop in the range of −2000 A/m to 2000 A/m using a single sheet tester using a 60 mm×60 mm specimen.

TABLE 1

| Steel | Alloy composition (area %) | | | | | | | | |
|---|---|---|---|---|---|---|---|---|---|
| type | Si | Al | Mn | Cr | S | P | N | Ti | Expression 1 |
| Comparative | 3.3 | 0.8 | 0.7 | 0.01 | 0.002 | 0.012 | 0.0032 | 0.0025 | 0.200 |
| Steel 1 | | | | | | | | | |
| Inventive | 3.3 | 0.8 | 0.7 | 0.05 | 0.001 | 0.01 | 0.0021 | 0.0027 | 0.043 |
| Steel 1 | | | | | | | | | |
| Comparative | 3.3 | 0.8 | 2.3 | 0.01 | 0.006 | 0.008 | 0.0011 | 0.0035 | 0.280 |
| Steel 2 | | | | | | | | | |
| Inventive | 3.3 | 0.8 | 2.3 | 0.05 | 0.002 | 0.008 | 0.0014 | 0.0015 | 0.024 |
| Steel 2 | | | | | | | | | |
| Inventive | 3.3 | 0.8 | 2.3 | 0.03 | 0.002 | 0.008 | 0.0018 | 0.0045 | 0.120 |
| Steel 3 | | | | | | | | | |
| Inventive | 3.3 | 0.8 | 0.7 | 0.04 | 0.002 | 0.008 | 0.0025 | 0.0036 | 0.072 |
| Steel 4 | | | | | | | | | |
| Comparative | 3.3 | 0.8 | 0.7 | 0.01 | 0.002 | 0.008 | 0.0005 | 0.0025 | 0.200 |
| Steel 3 | | | | | | | | | |
| Comparative | 3.3 | 0.8 | 0.7 | 0.05 | 0.002 | 0.008 | 0.0011 | 0.0008 | 0.013 |
| Steel 4 | | | | | | | | | |
| Comparative | 3.3 | 0.8 | 1.5 | 0.05 | 0.002 | 0.008 | 0.005 | 0.005 | 0.080 |
| Steel 5 | | | | | | | | | |
| Comparative | 3.3 | 1.7 | 1.5 | 0.01 | 0.002 | 0.008 | 0.0022 | 0.0063 | 1.071 |
| Steel 6 | | | | | | | | | |
| Inventive | 3.3 | 1.7 | 1.5 | 0.05 | 0.001 | 0.008 | 0.0017 | 0.005 | 0.170 |
| Steel 5 | | | | | | | | | |
| Inventive | 3.3 | 0.9 | 0.7 | 0.03 | 0.0005 | 0.008 | 0.0012 | 0.0015 | 0.045 |
| Steel 6 | | | | | | | | | |
| Inventive | 3.3 | 1.5 | 0.7 | 0.05 | 0.002 | 0.008 | 0.0031 | 0.0015 | 0.045 |
| Steel 7 | | | | | | | | | |
| Comparative | 3.3 | 1.5 | 0.7 | 0.008 | 0.002 | 0.008 | 0.0021 | 0.0015 | 0.281 |
| Steel 7 | | | | | | | | | |
| Comparative | 3.3 | 1.7 | 0.7 | 0.055 | 0.002 | 0.008 | 0.0032 | 0.0036 | 0.111 |
| Steel 8 | | | | | | | | | |
| Inventive | 3.3 | 1.7 | 1.8 | 0.01 | 0.002 | 0.008 | 0.0022 | 0.0034 | 0.578 |
| Steel 8 | | | | | | | | | |
| Inventive | 3.8 | 1.2 | 1.8 | 0.045 | 0.002 | 0.008 | 0.0021 | 0.0015 | 0.040 |
| Steel 9 | | | | | | | | | |
| Inventive | 3.8 | 1.3 | 1.5 | 0.05 | 0.002 | 0.008 | 0.0018 | 0.0021 | 0.055 |
| Steel 10 | | | | | | | | | |
| Inventive | 4.2 | 1.3 | 0.3 | 0.01 | 0.002 | 0.008 | 0.0033 | 0.0024 | 0.312 |
| Steel 11 | | | | | | | | | |
| Inventive | 3.5 | 1.7 | 0.3 | 0.05 | 0.002 | 0.008 | 0.0024 | 0.0035 | 0.119 |
| Steel 12 | | | | | | | | | |

Expression 1 Al × Ti/Cr

TABLE 2

| | | | | | | Difference | | | |
|---|---|---|---|---|---|---|---|---|---|
| | | | | | | between | | | |
| | | | | | | maximum | | | |
| | | | | | | heating | Difference | | |
| | | Maximum | | | | temperature | between | Number | |
| | | heating | Heating | Soaking | Soaking | and soaking | soaking time | density of | Coercive |
| | | temperature | time | temperature | time | temperature | and heating | precipitates | force |
| Division | Steel type | (° C.) | (sec.) | (° C.) | (sec.) | (° C.) | time (sec.) | (num./mm²) | (A/m) |
| Comparative | Comparative | 970 | 20 | 910 | 60 | 60 | 40 | 51 | 48 |
| Example 1 | Steel 1 | | | | | | | | |
| Inventive | Inventive | 1020 | 25 | 970 | 58 | 50 | 33 | 43 | 38 |
| Example 1 | Steel 1 | | | | | | | | |
| Comparative | Comparative | 970 | 19 | 910 | 60 | 60 | 41 | 56 | 45 |
| Example 2 | Steel 2 | | | | | | | | |
| Comparative | Inventive | 1015 | 23 | 985 | 55 | 30 | 32 | 55 | 47 |
| Example 3 | Steel 2 | | | | | | | | |
| Inventive | Inventive | 1020 | 12 | 970 | 48 | 50 | 36 | 35 | 38 |
| Example 2 | Steel 3 | | | | | | | | |
| Inventive | Inventive | 1005 | 21 | 955 | 62 | 50 | 41 | 31 | 34 |
| Example 3 | Steel 4 | | | | | | | | |
| Comparative | Comparative | 1024 | 18 | 965 | 55 | 59 | 37 | 65 | 51 |
| Example 4 | Steel 3 | | | | | | | | |
| Comparative | Comparative | 1000 | 20 | 940 | 75 | 60 | 55 | 70 | 57 |
| Example 5 | Steel 4 | | | | | | | | |
| Comparative | Comparative | 1015 | 18 | 960 | 67 | 55 | 49 | 66 | 45 |
| Example 6 | Steel 5 | | | | | | | | |
| Comparative | Comparative | 950 | 2 | 900 | 80 | 50 | 60 | 54 | 57 |
| Example 7 | Steel 6 | | | | | | | | |
| Comparative | Inventive | 1020 | 15 | 965 | 42 | 55 | 27 | 58 | 51 |
| Example 8 | Steel 5 | | | | | | | | |
| Inventive | Inventive | 1035 | 18 | 970 | 55 | 65 | 37 | 35 | 38 |
| Example 4 | Steel 6 | | | | | | | | |
| Inventive | Inventive | 1005 | 21 | 955 | 61 | 50 | 40 | 37 | 35 |
| Example 5 | Steel 7 | | | | | | | | |
| Comparative | Comparative | 1024 | 30 | 970 | 63 | 54 | 33 | 57 | 47 |
| Example 9 | Steel 7 | | | | | | | | |
| Comparative | Comparative | 1008 | 13 | 945 | 48 | 63 | 35 | 68 | 42 |
| Example 10 | Steel 8 | | | | | | | | |
| Inventive | Inventive | 1030 | 16 | 940 | 48 | 90 | 32 | 24 | 32 |
| Example 6 | Steel 8 | | | | | | | | |
| Inventive | Inventive | 1015 | 25 | 955 | 65 | 60 | 40 | 28 | 34 |
| Example 7 | Steel 9 | | | | | | | | |
| Comparative | Inventive | 950 | 25 | 980 | 51 | −30 | 26 | 57 | 47 |
| Example 11 | Steel 10 | | | | | | | | |
| Inventive | Inventive | 1023 | 16 | 964 | 61 | 59 | 45 | 34 | 35 |
| Example 8 | Steel 11 | | | | | | | | |
| Inventive | Inventive | 1015 | 17 | 965 | 48 | 50 | 31 | 24 | 31 |
| Example 9 | Steel 12 | | | | | | | | |

As can be seen from Tables 1 and 2 above, in the case of Inventive Examples 1 to 9 satisfying the alloy composition and manufacturing conditions proposed by the present disclosure, it can be seen that excellent magnetism is secured as the condition that the total number density of nitrides and carbides having a diameter of 1 to 3 μm is 50/mm² or less is satisfied.

In the case of Comparative Examples 1 to 11 not satisfying the alloy composition or manufacturing conditions proposed by the present disclosure, and it can be seen that the magnetism is at a low as the condition that the total number density of nitrides and carbides having a diameter of 1 to 3 μm is 50/mm² or less is not satisfied.

1. A non-oriented electrical steel sheet comprising by weight %:
3.3 to 4.3% of Si, 0.8 to 1.7% of Al, 0.3 to 2.5% of Mn, 0.01 to 0.05% of Cr, 0.005% or less (excluding 0%) of S, 0.01% or less (excluding 0%) of P, 0.001 to 0.004% of N, 0.001 to 0.005% of Ti, with a remainder of Fe and other inevitable impurities, and satisfying the following Relational Expression 1,
wherein a total number density of nitrides and carbides having a diameter of 1 to 3 μm of 50/mm² or less,
$$0.02 \leq Al \times Ti / Cr \leq 0.8 . \qquad [ Relational Expression 1 ]$$

2. The non-oriented electrical steel sheet of claim 1, wherein the non-oriented electrical steel sheet further includes at least one of 0.005% or less of C, 0.005% or less of Nb, and 0.005% or less of V.

3. The non-oriented electrical steel sheet of claim 1, wherein the non-oriented electrical steel sheet further includes at least one of 0.1% or less of Sn, 0.1% or less of Sb, 0.05% or less of Ni, 0.005 to 0.2% of Cu, and 0.01% or less of Zn.

4. The non-oriented electrical steel sheet of claim 1, wherein the non-oriented electrical steel sheet further includes at least one of 0.03% or less of Mo, 0.0050% or less of B, 0.005% or less of Ca, and 0.005% or less of Mg.

5. The non-oriented electrical steel sheet of claim 1, wherein the non-oriented electrical steel sheet further includes 0.20% or less (excluding 0%) of at least one of Bi, Pb, Ge and As, individually or in a total content thereof.

6. The non-oriented electrical steel sheet of claim 1, wherein the non-oriented electrical steel sheet has a coercive force of 40 A/m or less even after magnetization of up to 2000 A/m.

7. A method for manufacturing a non-oriented electrical steel sheet, comprising operations of:
heating a slab including by weight %, 3.3 to 4.3% of Si, 0.8 to 1.7% of Al, 0.3 to 2.5% of Mn, 0.01 to 0.05% of Cr, 0.005% or less (excluding 0%) of S, 0.01% or less (excluding 0%) of P, 0.001 to 0.004% of N, 0.001 to 0.005% of Ti, with a remainder of Fe and other inevitable impurities, and satisfying the following Relational Expression 1, at a temperature within a range of 1100 to 1250° C.;
finish hot rolling the heated slab at a temperature within a range of 800 to 1000° C. to obtain a hot-rolled steel sheet;
cold rolling the hot-rolled steel sheet at a reduction ratio of 70 to 95% to obtain a cold-rolled steel sheet; and
final annealing the cold-rolled steel sheet,
wherein the final annealing includes a heating process and a soaking process, and a maximum heating temperature is 50° C. or more than a soaking temperature, and a soaking time is 30 seconds or longer than a heating time,
$$0.02 \leq Al \times Ti / Cr \leq 0.8 . \qquad [ Relational Expression 1 ]$$

8. The method for manufacturing a non-oriented electrical steel sheet of claim 7, wherein the slab further includes at least one of 0.005% or less of C, 0.005% or less of Nb, and 0.005% or less of V.

9. The method for manufacturing a non-oriented electrical steel sheet of claim 7, wherein the slab further includes at least one of 0.1% or less of Sn, 0.1% or less of Sb, 0.05% or less of Ni, 0.005 to 0.2% of Cu, and 0.01% or less of Zn.

10. The method for manufacturing a non-oriented electrical steel sheet of claim 7, wherein the slab further includes at least one of 0.03% or less of Mo, 0.0050% or less of B, 0.005% or less of Ca, and 0.005% or less of Mg.

11. The method for manufacturing a non-oriented electrical steel sheet of claim 7, wherein the slab further includes 0.20% or less (excluding 0%) of at least one of Bi, Pb, Ge and As, individually or in a total content thereof.

12. The method for manufacturing a non-oriented electrical steel sheet of claim 7, after the operation of obtaining the hot-rolled steel sheet,
annealing the hot-rolled steel sheet at a temperature within a range of 850 to 1150° C.

13. The method for manufacturing a non-oriented electrical steel sheet of claim 7, wherein the cold rolling is performed once or twice.
